(19) United States
(12) Patent Application Publication
(10) Pub. No.: US 2002/0016926 A1
(43) Pub. Date: Feb. 7, 2002

(54) Method and apparatus for integrating tunneling protocols with standard routing protocols

(76) Inventors: Thomas T. Nguyen, Tampa, FL (US); Xavier Lujan, Tampa, FL (US)

Correspondence Address: Proskauer Rose LLP, Patent Department, 1585 Broadway, New York, NY, 10036, US

(21) Appl. No.: 09/843,605

(22) Filed: Apr. 26, 2001

Related U.S. Application Data
(60) Provisional application No. 60/199,984, filed on Apr. 27, 2000.

(51) Int. Cl. H04L 9/00; G06F 15/177

(52) U.S. Cl. 713/201; 709/220

(57) ABSTRACT

A group of Secure Gateway Devices is connected between their respective local area networks, and a public network (such as the internet). The Secure Gateway Devices create a cloud of virtual gateways that are all located at the same virtual IP address. On this network, standard routing protocols are used by network devices to pass their routing information, in real time, to each other. All communications between Secure Gateway Devices are done via IP tunnels using tunneling protocols.

### RELATED APPLICATIONS

This patent application claims the benefit of U.S. provisional application Ser. No. 60/199,984, entitled “AUTOMATIC IPSEC TUNNEL ADMINISTRATION,” filed on Apr. 27, 2000 for Thomas T. Nguyen and Xavier Lujan. The content of this provisional application is fully incorporated herein by reference.

This patent application includes subject matter related to U.S. patent application Ser. No. 09/001,698, entitled “Improved Network Security Device” filed on Dec. 31, 1997 for Aharon Friedman and Eva Bozoki, and U.S. Pat. No. 5,757,924 entitled “Network Security Device.” These patents and patent applications are assigned to Fortress Technologies, Inc., the assignee of this patent application. The contents of these documents are fully incorporated herein by reference.

### FIELD OF THE INVENTION

The present invention is directed to Secure Segment Communications Networks having tunnels. A Secure Segment Communications Network that is connected together by tunnels. Examples of Secure Segment Communications Networks include, but are not limited to, a Virtual Private Networks (VPN), or a network provider who uses the Internet infrastructure of another, but maintains his own address space through the use of tunnels connecting his site to the other providers site. The present invention provides a method and apparatus for automatically configuring and managing communication tunnels in a Secure Segment Communications Network. The invention preferably permits for the automatic setup, monitoring, and management of a Secure Segment Communications Network using routing protocols. The invention ties tunneling protocols to routing protocols. Routing protocols monitor the VPN, notify a network administrator of any changes that occur on the network, and monitor the current status of connections. The invention also uses standard address resolution protocols to support the exchange of current IP addresses. Thus, it allows for members of the network to use dynamically assigned IP addresses.

### BACKGROUND OF THE INVENTION

The present invention is a method and apparatus to facilitate the creation and management of a Secure Segment Communications Network, including, but not limited to a Virtual Private Network. Illustratively, the present invention operates in a network environment of the type described below.

### Network Architecture

An Internet communications network 100 is depicted in FIG. 1 including five transmit or backbone networks A, B, C, D, and E and three stub networks R, Y, and Z. A “backbone” network is an intermediary network that conveys communicated data from one network to another network. A “stub” network is a terminal or endpoint network from which communicated data may only initially originate or ultimately be received. Networks, such as the stub network R, may include one or more interconnected sub-networks I, J, L, and M. As used herein, the term “sub-network” refers to a collection of one or more nodes, e.g., (c, w), (d), (a), (b, x, y), (q, v), (r, z), (s, u), (e, f, g), (h, i), (j, k, l), (m, n), and (o, p), interconnected by wires and switches for local internodal communication. Each sub-network may be a local area network (or “LAN”). Each sub-network may have one or more interconnected nodes which may be host computers (“nodes”) u, v, w, x, y, z (indicated by triangles) or routers a, b, c, d, e, f, g, h, i, j, k, l, m, n, o, p, q, r, s (indicated by squares). A node can be an endpoint node from which communicated data may initially originate or ultimately be received, or a router that serves solely as an intermediary node between two other nodes. The router receives communicated data from one node and retransmits the data to another node. Collectively, backbone networks, stub networks, sub-networks, and nodes are referred to herein as “Internet Communications Networks”.

FIG. 2 shows a block diagram of a node or router 200. As shown, the node may include a CPU 201, a memory 202, and one or more I/O ports (or network interfaces) 203-1, 203-2, . . . 203-N connected to a bus 204. Illustratively, each I/O port 203-1, 203-2, . . . 203-N is connected by wires, optical fibers, and/or switches to the I/O port of another node. The I/O ports 203-1, 203-2, . . . 203-N are for transmitting communicated data in the form of a bitstream organized into one or more packets to another node and for receiving a packet from another node. If the node 200 is a host computer attached to a sub-network that is an Ethernet, then the node will have an I/O port which is an Ethernet interface.

A node that initially generates a packet for transmission to another node is called the source node and a node that ultimately receives the packet is called a destination node. Communication is achieved by transferring packets via a sequence of nodes including the source node, zero or more intermediary nodes, and the destination node, in a bucket brigade fashion. For example a packet may be communicated from the node w to the node c, to the node d, to the node b, and to the node x.

### Internet Protocol

An exemplary Internet Protocol (“IP”) packet 300 is shown in FIG. 3A having a payload 301 which contains communicated data (i.e., user data) and a header 302 which contains control and/or address information. Typically, the header information is arranged in layers including an IP layer, which contains network information, and a physical layer portion, which contains bit stream information.

As shown in FIG. 3b, the IP layer portion 400 typically includes an IP source address 402, an IP destination address 404, a checksum 406, a hop count 408 that indicates a number of hops in a multi-hop network. A data link layer header 500 includes a MAC (Media Access Control) address (hardware address) of the source node 502 and the destination node 504.

The user data may include a TCP (Transfer Control Protocol) packet including TCP headers or a UDP (User Data Protocol) packet including UDP headers. These well-known protocols control, among other things, the packetizing of information to be transmitted, the reassembly of received packets into the originally transmitted information, and the scheduling of transmission and reception of packets.

In Internet Protocol (IP), each node of the Internet is assigned a unique Internet address (IP address). The IP addresses are assigned in an hierarchical fashion. As shown in FIG. 3c, the Internet (IP) address of each node contains an address portion 601 indicating the network of the node, an address portion 602 indicating a particular sub-network of the node, and a host portion 603 which identifies a particular node or router and discriminates between the individual nodes within a particular sub-network.

In an Internet communications network 100 that uses the IP protocol, the IP addresses of the source and destination nodes are placed in the packet header 302 by the source node. A node that receives a packet can identify the source and destination nodes by examining these addresses.

Internet Protocol Security (“IPSec”) is a protocol that operates at a gateway, or a node, to protect IP traffic from unauthorized eavesdropping. The scope of this protection is defined by a Security Policy Database (SPD). After examining IP header and transport layer header information, and comparing it to information contained in entries located in the SPD, each packet will either be afforded IPSec security services, discarded, or allowed to bypass IPSec.

IPSec provides security services at the IP layer by enabling a system to select required security protocols, determine algorithms to be used by services, and put in place any cryptographic keys required to provide requested services.

IPSec can be employed to protect one or more paths between a pair of nodes, between a pair of security gateways, or between a security gateway and a node.

IPSec is further described in the following publication, the contents of which are fully incorporated herein by reference:

R. Atkinson, S. Kent, Security Architecture for the Internet Protocol (November 1998), available at http://wwvw.ietf.org/rfc/rfc2401 txt

IPSec, RFC 2401, available at http://www.faqs.org/rfcs/rfc2401.html

### Routing Protocols

There is a family of protocols designed and implemented for routers to pass information to each other. Examples of well-known routing protocols are Open Shortest Path First (OSPF), and Router Information Protocol (RIP). The latter has versions 1 and 2.

Routers use these protocols to pass to each other information regarding what the type, quality and amount of data that the router is capable of routing, the cost involved, and the number of hops involved in each route. Once this information is received, the router receiving this information builds a routing table containing routes to each destination.

Most routing protocols are designed for routers that share a common network. The common network could be a Local Area Network (LAN), such as Ethernet or 802.11, or a Wide Area Network (“WAN”) such as a Frame Relay or the Internet.

FIG. 4 demonstrates a typical network configuration using one of the above routing protocols. FIG. 4 shows LANs 1-3 714, 716, and 718 connected to each other through routers A-E 702, 704, 706, 710, 712, who are further connected to each other through a switch 700. Wide Area Network (WAN) 724 and the Internet 722 are also connected to the above-described network.

In this example, only those routers 702, 704, 706, 708, 710, and 712 that are connected directly to the switch 700 in a star configuration, use the routing protocols to exchange information. In FIG. 4, two routers provide access to the Internet 704, and 702. Router A 704 provides a preferred path, illustratively because it is more direct. If Router A 704 goes off line, all of the other routers 706, 708, 710, and 712 will pick router E 702 as an alternative path to reach the Internet (through LAN3 714 and router 720). In addition, LAN1 716 is routed through Router B 706 to the switch 700. However, if router B 706 goes off line, the other routers 702, 704, 710, and 712 will route to LAN1 716 through the high cost connection 726 provided by router C 710.

### Internet Key Exchange Security Protocol

The Internet Key Exchange (IKE) protocol is a key management protocol standard used in conjunction with LPSec. A “key” is typically a number that is used to encrypt or decrypt secure communications. IKE enhances IPSec by providing additional features, flexibility, and ease of configuration for the IPSec standard.

IKE automatically negotiates IPSec security associations (SAs) and enables IPSec secure communications without costly manual pre-configuration.

IKE is further discussed in the following documents, the contents of which are fully incorporated herein by reference:

Cisco Systems, inc., Internetworking Technology Overview, (IKE), available at http://www.cisco.com/univercd/cc/td/doc/product/software/ios113ed/113t/113t 3/isakmp.htm

IETF, The Internet Key Exchange, Internet Draft available at http:/www.draft-ietf-ipsec-isakmp-oakley-xx.txt

### Address Resolution Protocol

Address Resolution Protocol (ARP) is used to correlate IP addresses (i.e., a particular location of a node in the Internet network) to hardware addresses (i.e., a particular piece of hardware, such as a network interface card). When a computer needs to send an IP packet to a destination node, the computer first looks in its database and tries to find a corresponding hardware address to the destination node. Having failed to find a corresponding hardware address, the computer will then send an ARP request onto the network. An ARP request is an Ethernet frame broadcast. The ARP request includes the IP address of the destination node as well as the IP address and the hardware address of the source. This frame is selected by the computers on the LAN, but any computer with an IP address different from the destination identified in the frame will drop the request. Only the destination node will retain the frame. The destination node sends an ARP reply onto the network that contains its IP and hardware addresses. The reply is no longer a broadcast, but it is sent directly to the computer that originated the ARP request.

### Virtual Private Network (VPN)

VPN is defined as “customer connectivity deployed on a shared infrastructure with the same policies as a private network.” A shared infrastructure may be, for example, a frame relay network, or the Internet.

### Tunneling

A “tunnel” is a virtual, as opposed to a physical, connection between two or more nodes. To help understand what a tunnel is, in the context of a Secure Segment Communications Network, and what it does, one should first understand what a SGD is.

A SGD exists primarily as a specialized gateway node that function in groups of no less than two; one SGD being a peer of the other. Each SGD has at least two interfaces, such as a pair of SMC-Etherlink Network Interface Cards (NIC). Traditionally, each NIC is given a label, “Private Network Interface” (PRNI), and “Public Network Interface” (PUNI).

The PUNI connects the SGD to a public or shared communications infrastructure, such as the “Internet”. The PRNI connects the SGD to a private communications infrastructure, such as a “Local Area Network” (LAN).

As mentioned above, a SGD works in groups of two or more. This group of SGDs is configured in such a way that the “Private Network” (PRN) connected to each SGD PRNI are joined together, hence creating a Secure Segment Communications Network. The SGD joins each other's PRN by creating tunnels.

Therefore, the word “tunnel”, in this context, is used to describe a virtual connection between two or more nodes. This virtual connection, or tunnel, is what a SGD implements to join two or more PRNs cheaply, by using a shared communications media such as the Internet instead of costly leased communication lines.

A preferred embodiment of the present invention goes beyond establishing tunnels between PRNs. It establishes “SECURED” tunnels by using two secure communication protocols: SPS and/or IPSec. In a preferred embodiment, the SGD also provides services that automate the creation of secured tunnels.

Relative to the Internet, tunneling is using the Internet as part of a Secure Segment Communications Network. A Secure Segment Communications Network that is connected together by tunnels. Examples of Secure Segment Communications Networks include, but are not limited to, a Virtual Private Networks (VPN), or a network provider who uses the Internet infrastructure of another, but maintains his own address space through the use of tunnels connecting his site to the other providers site.

A “tunnel” is the path that a given message or file might travel from one member of the Secure Communications Network, to another member of the Secure Communications Network, through the Internet.

Point-to-Point Tunneling Protocol (“PPTP”), General Routing Encapsulation (E (“GRE”), IP over IP (“IPIP”) or other suitable tunneling protocols provide a manner in which a secure Segment Communications Network may be established using “tunnels” over the Internet. This is advantageous because a company having offices in different buildings, cities, or countries can avoid the expense of maintaining its own leased lines, and instead can use encrypted messages to securely use the public networks.

“Tunneling” involves encapsulating packets inside a protocol that is understood at the entry and exit points of a given network. These entry and exit points are defined as tunnel interfaces. The tunnel interface itself is similar to a hardware interface, but is configured in software.

VPN and Tunneling are further described in the following publications, the contents of which are fully incorporated herein by reference:

Cisco Systems, Inc., Internetworking Technology Overview, Virtual Private Networks (VPNs), available at

http.//www.cisco.com/univercd/cc/td/doc/cisintwk/ito_doc/vpn-htm

What's?com, Tunneling, available at

http://whatis.techtarget.com/definition/0.289893,sid9_gci213230,00.html

### Meshed VPN

FIG. 5 depicts a Meshed Virtual Private Network. A plurality of LANs 812, 814, 816, 818, 820 are connected to Virtual Private Networks (VPNs) 802, 804, 806, 808, and 810, respectively, which in turn connect all of the LANs to each other through though the Internet 800.

This setup is desirable when a high volume of communication is required. In this configuration, every local area network 812-820 can communicate directly with every other local area network. This configuration is advantageous because it results in an efficient use of communication lines and equipment, since no line or device has to be used twice for the same data.

### Star VPN

A VPN having a star configuration is shown in FIG. 6. FIG. 6 shows LANs 910-918 connected to VPNs 902-908, 920, which are in turn connected to each other through the Internet 900. One VPN is designated as the Main VPN 920.

The configuration shown in FIG. 6 requires each LAN 910-918 to communicate through a main VPN 920. A communication between LANs passes through the main VPN 920 to the Internet 900 twice. The volume of communication through that line is therefore twice the combined volume of communication through the other VPNs. This becomes quickly unmanageable, because the cost of a communication line grows exponentially with respect to its required volume.

For example, in a configuration having twelve local networks connected to the Internet via a T1 line, the main VPN 920 uses a T3 line. The main VPN 920 will also need the equipment necessary to operate on a T3 line (i.e., routers, Managed Security Servers, etc.). A star configuration VPN is currently not feasible for use in a large and busy network because of the costs.

In comparison to the star configuration, the meshed configuration of FIG. 5 does not pose the same problem, as each LAN only handles communications directed to it.

A problem with a meshed VPN is that it requires a much larger number of tunnels than the star configuration. For a VPN with n sites, the number of tunnels is n(n−1)/2. For example, the five site VPN of FIG. 5 has ten tunnels; and a hundred site VPN will have 100*99/2=4950 tunnels. Tunnel set up requires configuration at both sides of the tunnel. Hence, the number of tunnel setups actually doubles, and becomes n(n−1) (i.e., twenty for the five site VPN and 9,900 for the hundred site VPN). This presents a major scaling problem in the set up and maintenance of a Meshed VPN, and makes it impractical.

Another problem with a Meshed VPN is handling changes in network parameters. When any parameter changes in a VPN device, such as a device Internet address, a parameter of the networks behind that device (i.e. Network addresses, masks, routers, etc.), or the security parameters of the other device, that change should be implemented in all of the other VPN devices. This is particularly difficult when the VPN's Internet address is dynamically assigned, as is the case in many connections today, such as through the use of the Dynamic Host Configuration Protocol (“DHCP”). The IP address of the VPN can be changed automatically by the service provider as soon as the “lease” on the current address runs out. In a meshed VPN, this will put that LAN out of communication with all others LANs until the new IP address is manually entered into all of the other boxes. This is not feasible, and hence, forces the user to require static IP addresses. This increases the price of networking, and reduces the flexibility of the network.

An additional problem found in traditional secured Virtual Private Networks (VPNs) is in the amount of work required to maintain routing tables. Each VPN device requires careful configuration of routing entries describing the path that a payload must take to reach one among a number of possible protected private networks.

As an example, in a hypothetical network of 100 VPN devices, the administrator will have to configures 99 routing entries on each SGD. This is a total of n(n−1)=9900 routing entries. If one of the VPN devices is using DHCP to acquire its public interface IP address dynamically, then the network becomes unmanageable, since the administrator will have to reconfigure each VPN device again every time the lease expires.

An additional problem in prior art networks is that private network information is required in order to configure tunnels. This private network information may include network addresses, subnet masks, the broadcast addresses behind the VPN, and information on all of the routers behind the VPN.

Therefore, it is one object of the present invention to implement a Secure Segment Communications Network that responds flexibly to changes in network parameters.

It is another object of the present invention to optimize the routing of broadcast and multicast transmissions on a secured segment communications network.

It is another object of the present invention to automate the creation and maintenance of routing tables.

It is another object of the present invention to produce a device that can configure network tunnels without the manual entry of private network information by automatically discovering that information.

It is another object of the present invention to provide a device that facilitates operating, configuring, and monitoring a meshed VPN that overcomes the scaling, set up, and maintenance problem of prior art meshed VPN.

It is another object of the present invention to provide a device which facilitates the creation, configuration, and monitoring of a meshed configuration VPN that is suitable for use as a large scale VPN.

### SUMMARY OF THE INVENTION

These and other objects of the present invention are achieved by creating a Secure Segment Communications Network, where nodes are connected to each other through secure gateway devices. A Secure Segment Communications Network that is connected together by tunnels. Examples of Secure Segment Communications Networks include, but are not limited to, a Virtual Private Networks (VPN), or a network provider who uses the internet infrastructure of another, but maintains his own address space through the use of tunnels connecting his site to the other providers site. One or more secure gateway device(s) on the secure communications network are designated as the “Managed Security Server” (“MSS”) secure gateway device, and configure the other secure gateway devices and the Secure Segment Communications Network.

A preferred embodiment of the present invention is a method for creating a Secure Communications Network composed of a plurality of local area networks and at least one wide area network. These local area networks may physically be located anywhere in the world that the wide area network reaches.

A plurality of secure gateway devices connects the local area networks to each other through a wide area network through the use of tunneling.

The Managed Security Server is assigned a static IP address. All of the other secure gateway devices may have either static or dynamically assigned IP addresses. It is desirable for each secure gateway device to know the static IP address of the secure Managed Security Server gateway device for it to be a part of the virtual private network. Each secure gateway device transmits its IP address to the Managed Security Server for storage.

Configurations of the virtual network, including but not limited to security services parameters, tunneling and routing information, are performed by the Managed Security Server. One advantage made possible by the present invention is the elimination of the multiple configuration changes previously required to implement a change on a prior art network.

### BRIEF DESCRIPTION OF THE DRAWINGS

The following detailed description, given by way of example and not intended to limit the present invention solely thereto, will best be understood in conjunction with the accompanying drawings in which:

FIG. 1 schematically illustrates an Internet system.

FIG. 2 schematically illustrates the architecture of a node in the network of FIG. 1.

FIGS. 3a, 3b, and 3c illustrate the format of a packet transmitted in the network of FIG. 1

FIG. 4 illustrates a router configuration.

FIG. 5 illustrates a Meshed VPN configuration.

FIG. 6 illustrates a Star VPN configuration.

FIG. 7 illustrated a method for configuring a secured segment communications network in accordance with an embodiment of the present invention.

FIG. 8A illustrates a secure gateway device for use in the network of FIG. 1 in accordance with an embodiment of the present invention.

FIG. 8B illustrates a secure gateway device for use with a LAN in accordance with an embodiment of the present invention.

FIG. 9 illustrates a setup for a secure gateway.

FIG. 10 illustrates an architecture for a SGD.

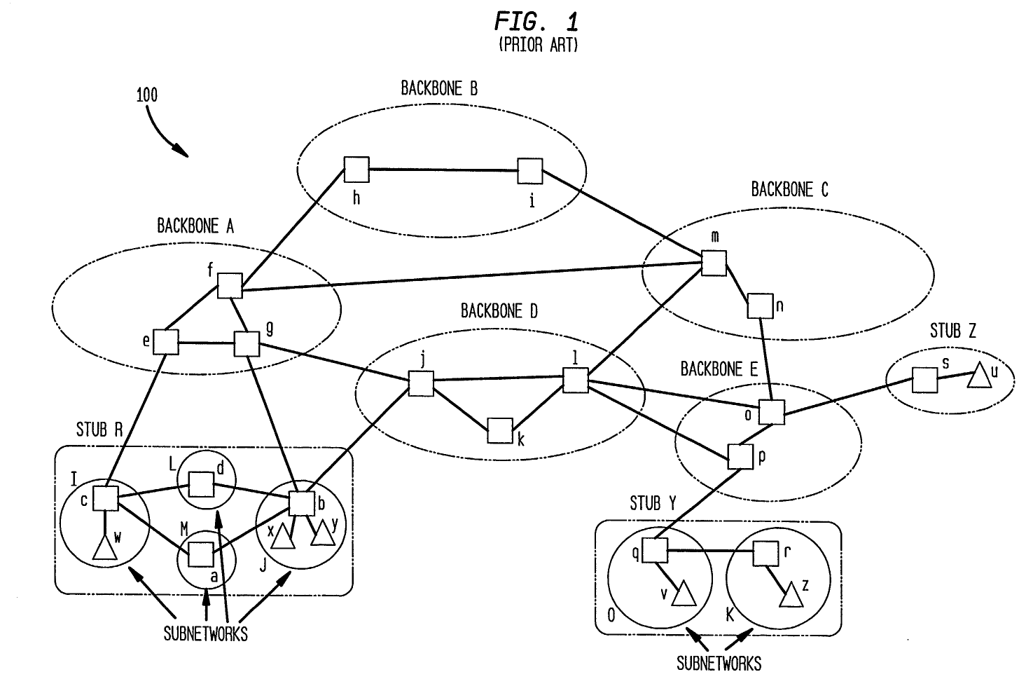

### DETAILED DESCRIPTION OF PREFERRED EMBODIMENTS

A preferred embodiment of the present invention is a method and apparatus for creating a Secure Segment Communications Network, such as a VPN, comprising at least a pair of secure gateway devices to form a Secure Segment Communications Network, such as a virtual private network, between at least two nodes. One of the secure gateway devices in the Secure Segment Communications Network is designated as the “Managed Security Server” secure gateway device. The Managed Security Server configures the other secure gateway devices and the Secure Segment Communications Network.

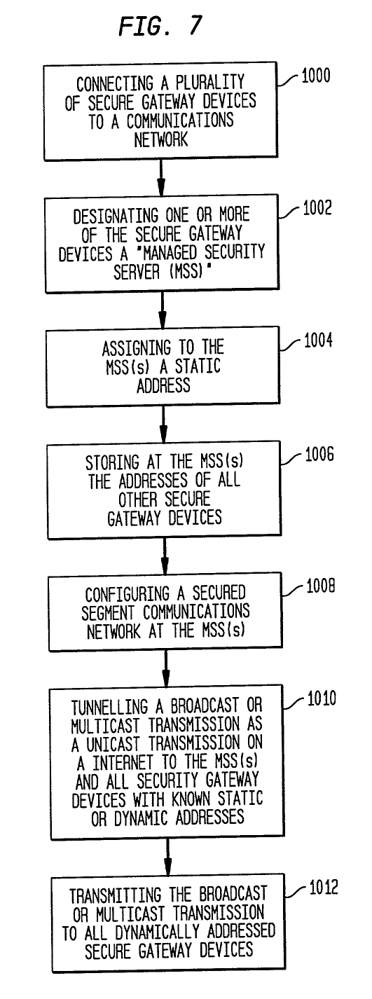

In a preferred embodiment, as illustrated in FIG. 7, a plurality of secure gateway devices are connected to a communications network 1000. One or more of the secure gateway devices is designated a “Managed Security Server” gateway device 1002. The Managed Security Server is assigned a static IP address 1004. All of the other secure gateway devices send their virtual addresses to the Managed Security Server to be stored 1006. The Managed Security Server then uses this information in part to configure a secured segment communications network 1008. A broadcast or multicast transmission will be transmitted as a uni-cast transmission to any SGD's with known dynamic or static addresses, including the MSS 1010. The broadcast or multicast will then be re-transmitted to all SGD's with dynamically assigned addresses 1012.

As discussed above, prior art networks require an extensive amount of work to configure tunnels in the network. Prior art networks additionally require a greater number of tunnels. For example, consider a prior art network with 100 SGDs. The total number of tunnels required without the present invention is n(n−1) or 9900. By utilizing the present invention, the number of tunnels can be reduced to 2(n−1), or 180.

To further illustrate, assume that the above network of 100 SGDs has been fully configured. Adding another SGD to the network will required the administrator to visit each SGD and configure one more tunnel. Additionally, the new SGD will have to be configured with 100 tunnels. This is a total of 200 more tunnels that need to be configured just to add one more SGD to the network.

On the other hand, when using the present invention, the administrator only needs to configure two more tunnels: one to be added to the designated as the Managed Security Server (“MSS”) SGD, and one on the SGD that was added to the network. The MSS handles the rest of the work required to fully-mesh the network again.

The present invention exponentially reduces the amount of work required by an administrator to configure a fully-meshed network of SGDs.

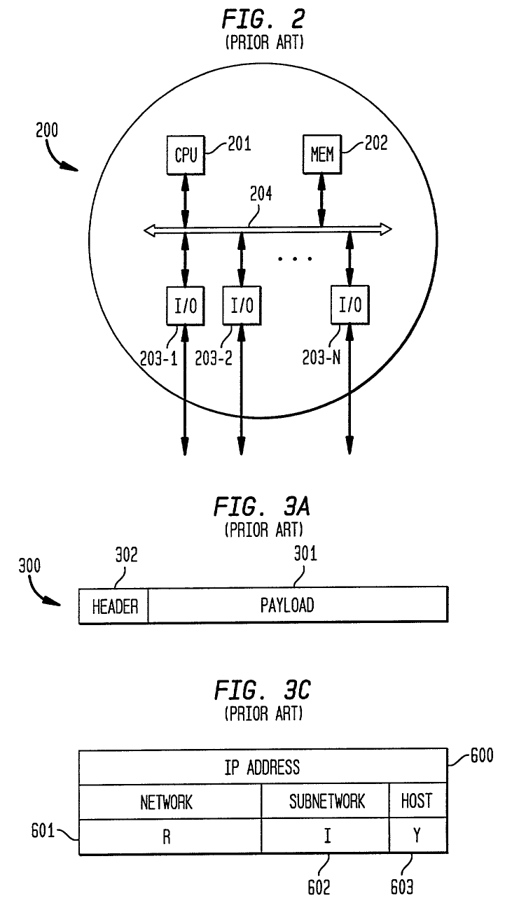

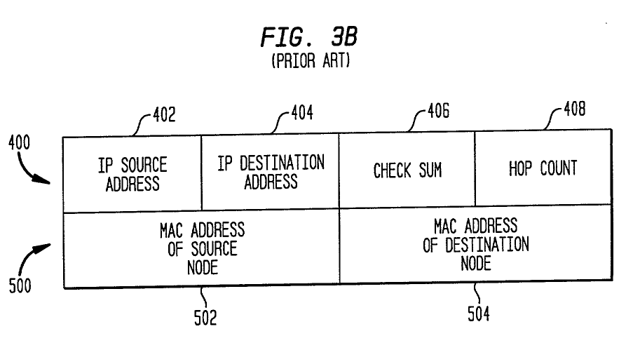

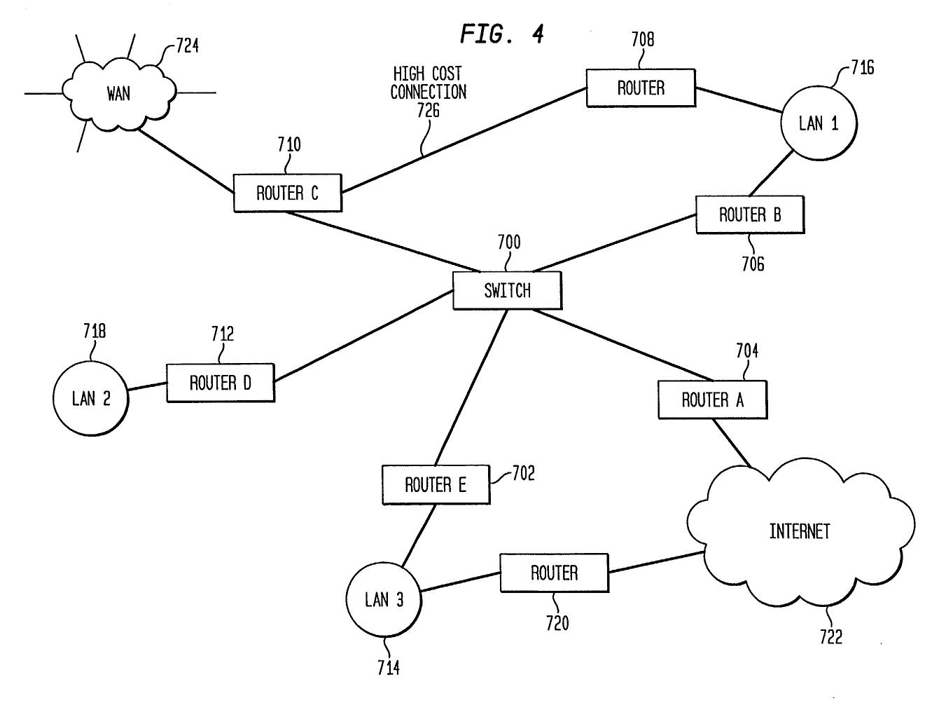

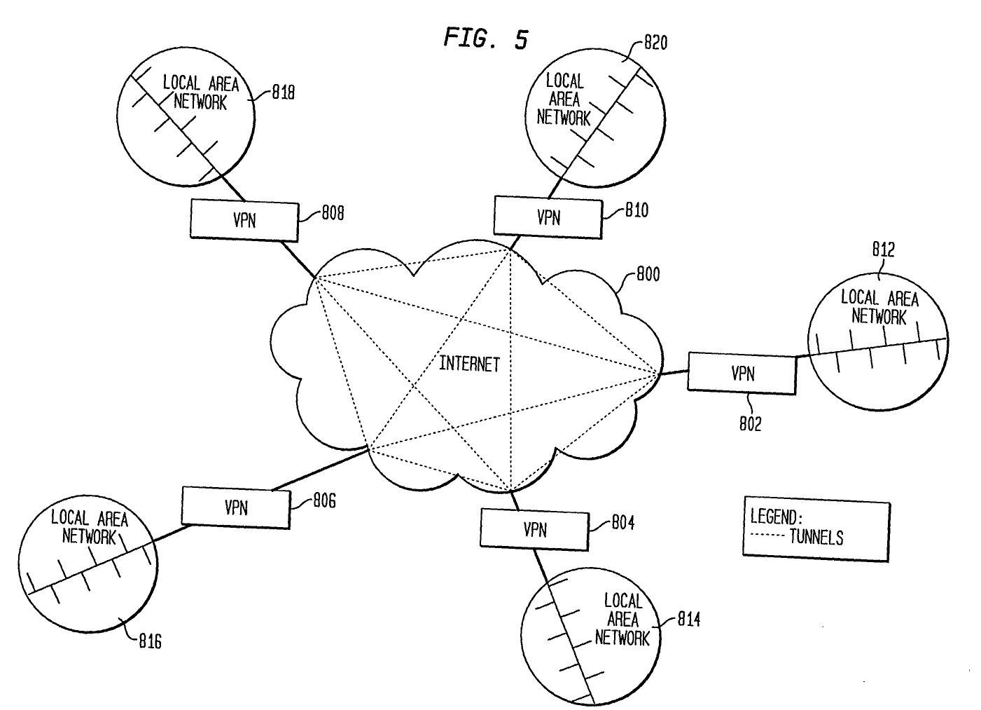

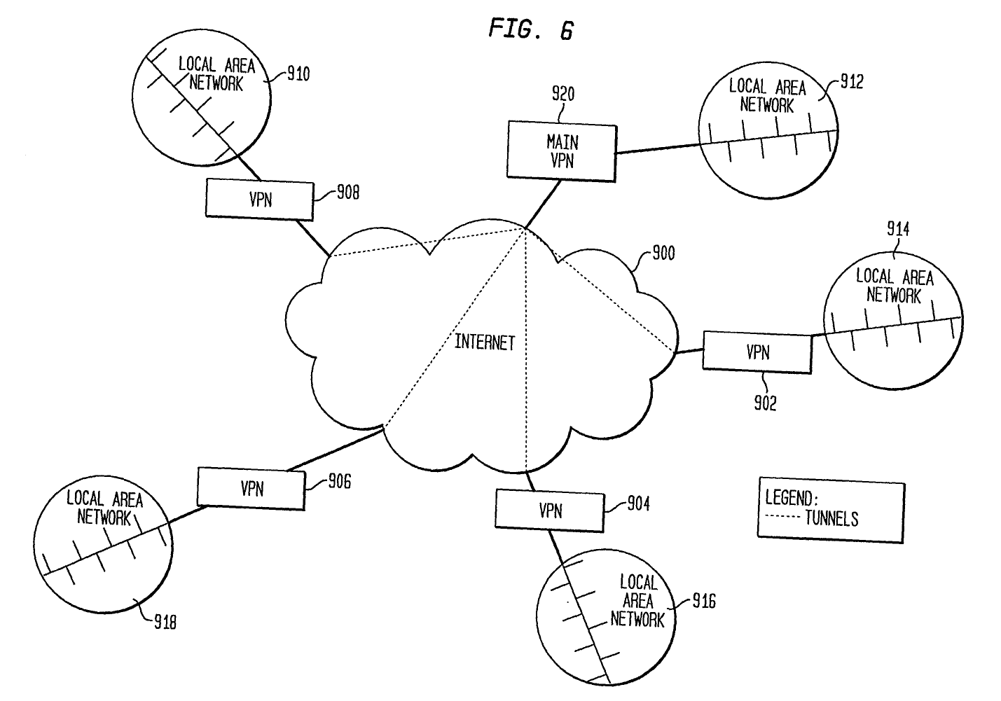

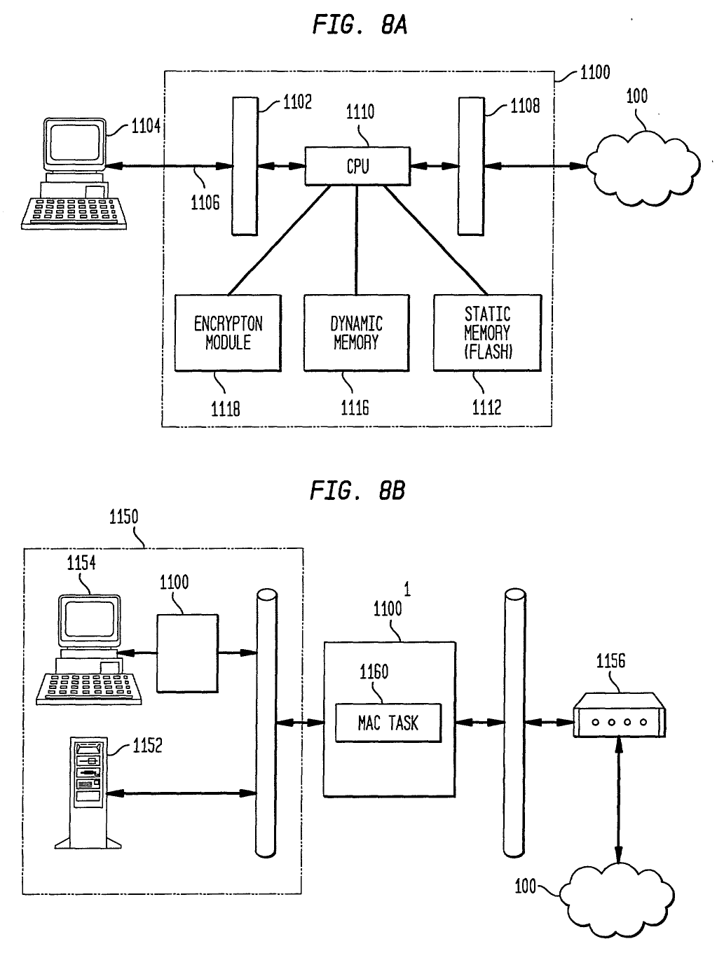

FIG. 8a illustrates a secure gateway device for protecting a node according to one embodiment of the present invention. A person skilled in the art recognizes that although any suitable SGD device may be used, a preferred embodiment described below using the Net Fortress® sold by Fortress Technologies, Inc. of Tampa Fla., and described in U.S. Pat. No. 5,757,924 and application Ser. No. 09/001,698 incorporated by reference, as the SGD. It should be clear that the invention is not limited to this preferred embodiment but may instead employ routers, servers, or switches. The security device 1100 comprises a first interface 1102, which is connected to the client node 1104. Specifically, the interface 1102 is connected to a network interface in the client node 1104 (e.g., an interface 203 of FIG. 2) via a cable or wire 1106. The security device 1100 comprises a second interface 1108, which is connected to a portion of a network 100. Illustratively, the interface 1108 is connected to an Ethernet so that the interfaces 1102, 1108 are Ethernet interfaces such as SMC Elite Ultra Interfaces. However, the total number of interfaces may be more than two, and the interfaces could be other than Ethernet, such as cable modem, a wireless interface, a frame relay, etc.

FIG. 8b schematically illustrates one example of a secure gateway device 1100′ for protecting a LAN according to an embodiment of the invention. As seen in FIG. 8b, a secure gateway device 1100′ according to the invention is connected between a LAN 1150, such as an Ethernet network (including, for example, a file server 1152 and a workstation 1154), and a router 1156 which routes communications between the LAN 1150 and a WAN 100, such as the Internet. As also seen in FIG. 8b, secure gateway devices may be arranged in a cascaded topology. Note that workstation 1154 is associated with a secure gateway device 1100.

### Automatic Tunnel Administration (ATA)

One aspect of the present invention is a method and apparatus of setting up and administering fully meshed tunnels. This is referred to in the present application as Automatic Tunnel Administration (ATA). One embodiment of the present invention is marketed by Fortress Technologies as a part of their Net Fortress® M series product. ATA uses dynamic routing protocols. These dynamic routing protocols may include, but are not limited to the well known dynamic routing protocols RIP, RIP2 and OSPF.

The present invention preferably fully automates the configuration and maintenance of routing information among SGDs. ATA is a method of obtaining private-network routing information preferably without any system administrator involvement.

As discussed above, as a network grows in complexity, the number of tunnels required grows by a factor of N* (N−1), where N is the number of nodes in the network. The present invention simplifies the setup and administration of these large meshed networks.

One embodiment of the present invention creates a Secure Segment Communications Network by connecting nodes through a network backbone. Illustratively, the network backbone could be a wide area network or the Internet.

Each secure gateway device is given a virtual IP address that is independent of any other IP address on the Secure Segment Communications Network. A virtual IP address is the address assigned to the Network Virtual Interface Driver (“NFID VNIC”) 1232 Each secure gateway device also has a public IP address that is visible to nodes outside of a node(s) protected by the secure gateway device, and a hidden IP address (such as the virtual IP address), that is not visible to a node other than the node(s) protected by the secure gateway device. In a preferred embodiment, at least one SGD has a static public IP address. A static address is an address that remains constant, or changes less frequently as compared to a dynamic address. This secure gateway device having a static IP address will be referred to as the “Managed Security Server”.

Each remote secure gateway device knows the static public address of the Managed Security Server. When a new dynamic address is assigned to the remote secure gateway device, the remote secure gateway device will open a registration channel to the Managed Security Server, and relay the remote secure gateway device's information to the Managed Security Server unit. Illustratively, this registration channel may be encrypted and secure.

Once a remote secure gateway device registers its dynamically assigned address with the Managed Security Server, it becomes a part of the Secure Segment Communications Network. Any source node wishing to communicate to the SGD having the dynamically assigned address sends an ARP request to the Managed Security Server. The ARP packet has the virtual IP address in the IP address field and the public IP address is encoded as the MAC address (the hardware address). The Managed Security Server forwards the ARP request to the dynamic secure gateway device, which would then reply with an ARP response. In a preferred embodiment, this ARP request may be an ATA/ARP request, which is an ARP request encapsulated in an IP packet, and encrypted.

This configuration creates a situation where, from an IP perspective, the secure gateway devices appear to be a part of the same LAN (or WAN) as all other secure gateway devices. This form of a Secure Segment Communications Network is referred to as a Virtual Private LAN (“VPLAN”).

Running on top of the above-described scenario is a routing protocol, such as OSPF or RIP. Routing multi-casts and broadcasts are encapsulated in a unicast IP packet and encrypted before being sent to all static and dynamic IP secure gateway devices whose addresses are known at the time. The Managed Security Server (or Managed Security Servers) resends the received multicasts and broadcasts to the dynamic secure gateway devices. Thus, each secure gateway device builds a routing table with all of the identification data of every other secure gateway device. The next hop is the virtual IP address of that secure gateway device unit.

Because these connections are automatically configured, and routes are propagated through the network, the fully meshed set of tunnel connections is configured. If a route located in the routing table becomes unavailable for any reason (i.e. a failure, movement, etc.), the route entry corresponding to the route will be removed from the routing table by the secure gateway device. A backup route may be implemented automatically, if one can be configured. If the first route again becomes available, the tunnel will be automatically reconfigured.

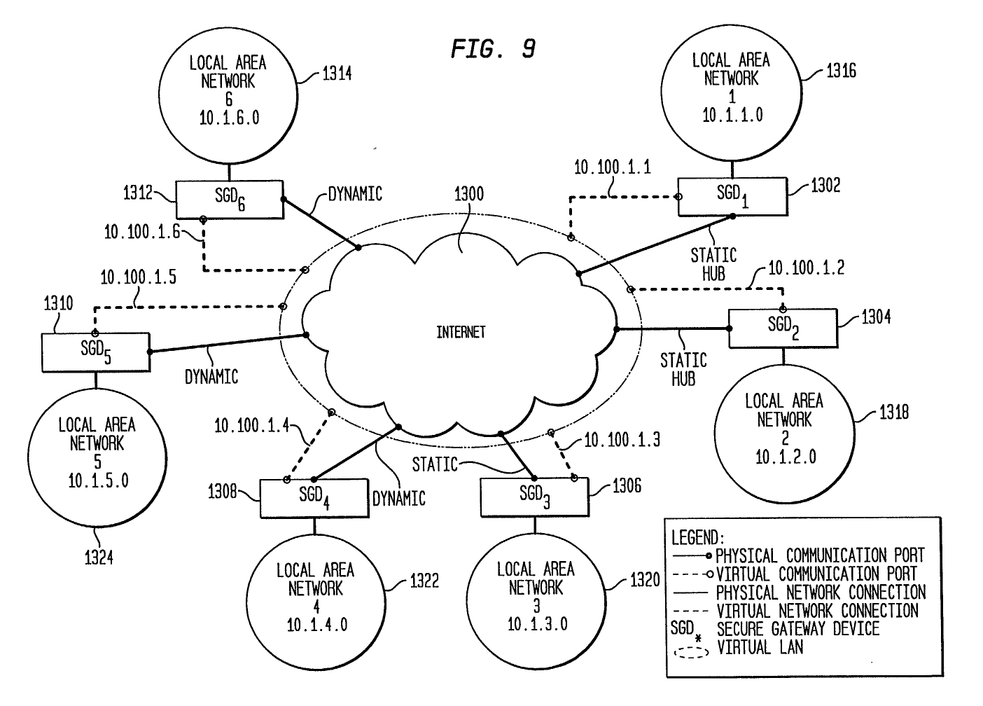

FIG. 9 depicts a network based on Secure Gateway Devices. A plurality of nodes 1314-1324 are connected to a plurality of secure gateway devices (SGDs) 1302-1312, which are in turn connected to a communications network, such as the Internet 1300. Illustratively, these nodes may be LANs, or host computers.

Each SGD has two or more communication ports. At least one of these ports is connected to a LAN and the SGD is set as the default gateway for that LAN. At least ell one of these ports is connected to the Internet (or another public network). The IP address of the LAN port is set manually, and is part of the network address of the LAN to which it is connected. This network address is a private address space that is not part of the Internet, and therefore not exposed to it. The IP address of the port that is connected to the Internet may be a static IP address, or the IP address may be a dynamically assigned IP address acquired from a DHCP server, which is renewed periodically. At least one of the SGDs 1302-1306 has a static address.

Each SGD has at least one Virtual Port. The Virtual Port is a port that has a static, private IP address that is part of a network address shared by all SGDs. The Virtual Port also has a hardware address, which is a binary representation of the IP address of the Internet port. As this address changes, the hardware address of the Virtual Port changes accordingly.

The ARP broadcasts and the routing protocol broadcasts are all done on the Secure Segment Communications Network. When a SGD sends a broadcast or multicast to another SGD, the data is sent through the SGDs respective virtual ports. Data passing between the virtual ports of two SGDs is tunneled and encrypted.

### Automatic Update And Recovery

By using an encrypted routing protocol and virtual IP address, each client configured on the Secure Segment Communications Network, such as a meshed secure virtual LAN, or a meshed secure VPN receives a routing update request in predefined intervals, such as every 5 minutes. In the event that a client is disabled, fails, or has received new information such as a renewed IP address, the new information will be propagated throughout the meshed network so that the tunnels can be automatically reconfigured, taken down in the event of a node failure, or new tunnels added for nodes coming online.

For Secure Segment Communications Networks configured with redundant node units, concurrent information is maintained for clients. As the clients parse the information, any tunnel already established is ignored if it was already encountered and previously setup. Any Managed Security Server (“MSS”) configured as part of the Secure Segment Communications Network will automatically update its existing database with any changes that propagate through the network thus permitting concurrent tunnel configuration databases to be maintained.

### Secured ATA Traffic And Configuration

Routing and tunneling information that propagates through the Secure Segment Communications Network is encrypted. Routing updates are passed through encrypted tunnels, thus securing the integrity of the Secure Segment Communications Network.

### Automatic Configuration Of IPSec And IKE

One embodiment of the present invention is a method used with the ATA NetFortress®. The present invention allows a Secure Segment Communications Network to acquire IPSec configuration information from the Managed Security Server(s). This is advantageous because the system administrator may enter the Virtual Private LAN (VPLAN) information at the Managed Security Server. The administrator provides the peers with information to reach the Managed Security Server. ISAKMP (Internet Security Association and Key Management Protocol) and IPSec are automatically established, using pre-shared or public keys for authentication. When using the pre-shared key method of authentication, each member of the Secure Segment Communications Network automatically generates the shared keying material, which eliminates the logistics of distribution and management of pre-shared keys.

### Architecture Of The SGD

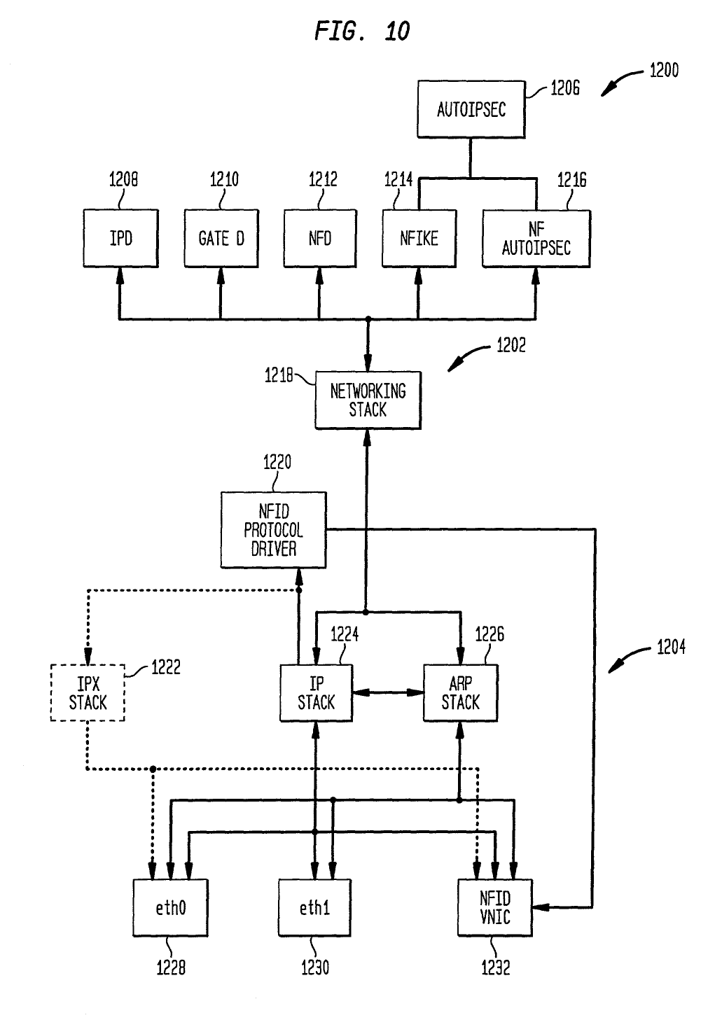

The SGD internal architecture works in three separate layers as depicted in FIG. 10. At the bottom of the stack is an interface driver, such as the Net Fortress Network Interface Driver (NFID) 1204. In the middle of the stack is a protocol driver, such as the proprietary NFID protocol driver 1202. At the top of the stack are the various applications taking care of key exchange, routing protocols, data base management, etc. 1200. The various components that comprise the SGD are described below.

### NFID Virtual Network Interface Card (VNIC)

The NFID VNIC is a virtual network interface. It is implemented as loadable module of the Operating System kernel. The virtual driver is assigned a non-routable IP, as defined in IETF's RFC 1918, such as 192.168.10.20. With the assignment of a network address, each SGD becomes a part of the secured segment communications network. The virtual driver, being the default gateway for the private network, is designed to process traffic routed to it by applying SPS, a proprietary tunneling standard used by Fortress Technologies, Inc. as a part of their NetFortress®, and/or IPSEC services.

On receiving from the IP stack a packet to be sent out, the NFID VNIC looks at the Ethernet header of the packet and takes the destination Ethernet address. This address is the binary representation of the actual IP address of the targeted SGD. NFID builds a tunnel based on this address. The tunnel could be any standard based tunnel, such as an IPSec tunnel, GRE tunnel, or a proprietary SPS tunnel. The tunneled packet is then sent back to the IP stack to be routed on standard routes and NICs to the Internet.

When a tunneled packet arrives, the IP stack hands it to the NFID protocol, which in turn hands it to the NFID VNIC for detunneling. Once the packet is detunneled it is handed back to the IP stack to be handled in a conventional manner.

### Handling Broadcasts And Multicasts

An important function of the NFID 1204 is to handle broadcasts and multicasts coming in and going out of the Secure Segment Communications Network. An outgoing broadcast or multicast will be tunneled and a duplicate sent to every known SGD including static SGDs, and dynamic SGDs with known public address.

When a tunneled broadcast or multicast is received, only a Managed Security Server SGD will duplicate the broadcast, detunnel it, and resend it to all the remote SGDs with known public or destination IP addresses at the time. This means that remote SGDs may receive the same broadcast or multicast more than once, one in a tunneled form, and then again after the broadcast or multicast has been de-tunneled by the Managed Security Server. This is desirable, since it covers the case where the Managed Security Server is down and another secure gateway device has to step in and configure the network.

Once a tunneled broadcast is detunneled, it is given to the IP or IPX stack for further handling in the conventional manner.

### Handling Keys And Associations

In order to handle keys and associations, NFID 1204 uses the upper level applications; AIPSec 1206, NFIKE 1214, NFD 1212, and NF Auto IPSec 1216 as needed. This process if further detailed in U.S. patent application Ser. No. 09/001,698, entitled “Improved Network Security Device” the contents of which are fully incorporated herein by reference.

### NFID Protocol Driver

This is a protocol subroutine called by the IP stack when a tunneled packet arrives. The NFID protocol driver work in concert with the NFID VNIC. The NFID protocol driver is the implementation of the logic that handles the processing of payloads with protocols numbers within the domain of IPSec and SPS. The NFID protocol driver's processing, includes, but is not limited, to the de-envelope, re-envelope, decryption, encryption, and authentication of payloads.

### NFD

This is a service that handles the key exchange and authentication for SPS. It communicates with the kernel driver or communicates with NFID 1204. It is also used by NFID 1204 to provide cryptographic material for IPSec's public session key authentication method. NFD can be implemented as a kernel driver, or as any application service (daemon).

### IP Daemon

This is a service that handles the registering and distribution of the SGDs public IP addresses. The IPD 1208 registers itself with the Managed Security Server giving it its current IP address. In return it receives from the IPD of the Managed Security Server its current database. A dynamically addressed SGD will reregister with the Managed Security Server whenever it is assigned a new IP address and in such case the Managed Security Server will notify the other SGD of the change.

### Gated

This is a public domain software that handles the routing protocols and builds a routing table. It can also be used to notify computers on the LAN listening to routing protocols about the state of the SGD.

### Automatic IPSec (AIPSec)

A service used by NFID 1204 to establish IPSec SA. AIPSec 1206 is composed of two components NFIKE 1214, and NF-Auto IPSec 1216. Illustratively, the SGD may implement a subset of the IKE protocol as defined in IETF's RFC-2409. One embodiment of the present invention enhances the IKE protocol by automating the creation of secured tunnels, with minimal required manual intervention.

### NFIKE

NetFortress Internet Key Exchange, (“NFIKE”) is an implementation of Request For Comments (“RFC”) 2409 fro the IETF (IKE), which handles authentication, automatic rekeying, key material generation, and the negotiation of security services. NFIKE is activated by NF Auto IPSec 1216, which provides it with all the configuration information necessary to establish and tear down SAS. It uses the standard UDP port to communicate with its peers. NFIKE 1214 will communicate with other IKE implementation not part of the SGD.

The sequence of events in NFIKE to establish Phase 1 and Phase 2 SAs, as defined in the IPSEC RFC's is well documented in the IPSEC RFCs (NFIKE implementation excludes Aggressive Mode). NFIKE goes a step further, by automating Phase 2 and by populating the Security Policy Data Base (“SPDB”), as defined by RFC 2409, and the Security Association Database (“SADB”) with a pre-arranged configuration.

### NF AUTO IPSEC

This is a service to the NFID 1204. It is triggered by it when NFID 1204 detects an unavailable IPSec tunnel that it needs to use. NFAutoIPSec handles virtual-driver requests for building and tearing down IPSec SAs. It is a service called by NFID 1212. NFID 1612 uses this service to trigger the creation of new IPSec tunnels when it detects that an IPSec tunnel is not available to reach a particular node.

NFAutoIPSec also respond to deletion commands from NFID 1212. The default security-policy information needed to create IPSec Phase1 and Phase 2 Security Associations (SA) is built into this service, thus minimizing the amount of work to the administrator.

As this invention may be embodied in several forms without departing from the spirit of essential characteristics thereof, the present embodiment is therefore illustrative and not restrictive, since the scope of the invention is defined by the appended claims rather than by the description proceeding them, and all changes that fall within metes and bounds thereof are therefore intended to be embraced by the claims.

We claim:

1. A Managed Security Server for use in a Secure Segment Communications Network, the Managed Security Server comprising:
(a) a memory to store an address of at least one secure gateway device, wherein said secure gateway device is a member of the Secure Segment Communications Network; and
(b) a processor for configuring said Secure Segment Communications Network by configuring the at least one secure gateway device.

2. The Managed Security Server of claim 1 wherein the Managed Security Server is a secure gateway device.

3. The Managed Security Server of claim 1 further comprising: wherein the memory stores a static public IP address, wherein the static public IP address is assigned to the Managed Security Server.

4. The Managed Security Server of claim 3 further comprising the at least one secure gateway device, the secure gateway device has a memory containing the static public IP address of the Managed Security Server.

5. The Managed Security Server of claim 1 wherein the address of the at least one secure gateway device is dynamically assigned.

6. The Managed Security Server of claim 1 further comprising:
wherein the input is additionally configured to receive a request for an address of a destination node, wherein the destination node is a part of said Secure Segment Communications Network.

7. The Managed Security Server of claim 6 wherein the request is tunneled and encrypted.

8. The Managed Security Server of claim 6 wherein said request is further comprised of an IP packet, wherein the IP packet has the virtual IP address in a IP address field and a public IP address encoded as a hardware address in a hardware address field.

9. The Managed Security Server of claim 6 further comprising:
an output configured to receive the request for an address from the second input, and to transmit the request for an address to the destination node.

10. The Managed Security Server of claim 9 wherein the destination node responds to the forwarded request for an address with an address response.

11. The Managed Security Server of claim I wherein a communication from a local area network to a second local area network is transferred through a wide area network by the at least one secure gateway devices through a tunnel.

12. The Managed Security Server of claim 1 further comprising:
wherein the output is also configured to output tunnel configuration information to the at least one secure gateway device.

13. The Managed Security Server of claim 1 further comprising
wherein the input is additionally configured to receive a transmission of data intended for a destination node.

14. The Managed Security Server of claim 13 further comprising
wherein the output is additionally configured to transmit the transmission of data to a secure gateway device that corresponds to the destination node.

15. The Managed Security Server of claim 1 further comprising:
wherein the output is additionally configured to transmit to the Secure Segment Communications Network IPSec configuration information.

16. The Managed Security Server of claim 1 further comprising:
wherein the output is additionally configured to transmit to the Secure Segment Communications Network IKE configuration information.

17. A method of managing a Secure Segment Communications Network, wherein the Secure Segment Communications Network is further comprised of a plurality of secure gateway devices, the method comprising the steps of:
(a) connecting the plurality of secure gateway devices to a communications network; and
(b) designating one of the plurality of secure gateway devices to be a Managed Security Server, wherein the Managed Security Server configures the Secure Segment Communications Network.

18. The method of claim 17 further comprising the step of:
(c) configuring the Secure Segment Communications Network at a second Managed Security Server secure gateway.

19. The method of claim 17 further comprising:
(c) assigning each secure gateway device of the plurality of secure gateway devices of step (a) an address that is independent of any other address on the network.

20. The method of claim 17 further comprising the step of
(c) assigning the Managed Security Server a static public IP address.

21. The method of claim 20 further comprising the step of:
(d) storing at each secure gateway device of the plurality of secure gateway devices of step(a) the static public IP address of the Managed Security Server.

22. The method of claim 19 further comprising the step of
(d) dynamically assigning the address of step (c).

23. The method of claim 22 further comprising the step of:
(e) opening a registration channel from each of the secure gateway devices of the plurality of gateway devices of step (a) to the Managed Security Server; and
(f) conveying the dynamically assigned address of step(d) to the Managed Security Server.

24. The method of claim 23 further comprising the step of
(g) sending a request for an address of a destination node from a source node to the Managed Security Server, wherein the destination node is a part of said Secure Segment Communications Network.

25. The method of claim 24 wherein the request is tunneled and encrypted.

26. The method of claim 24 wherein the request is further comprised of an IP packet, wherein the IP packet has the virtual IP address in a IP address field and a public IP address encoded as a hardware address in a hardware address field.

27. The method of claim 24 further comprising the step of:
(h) forwarding the request for an address of a destination node of step (g) from the Managed Security Server to the destination node.

28. The method of claim 27 further comprising the step of
(i) responding to the forwarded request for an address at the destination node of step (h) with an address response.

29. The method of claim 17 further comprising the step of:
(c) tunneling a communication from a local area network to a second local area network through the plurality of secure gateway devices.

30. The method of claim 17 further comprising the step of:
(c) providing tunnel configuration information from the Managed Security Server to the plurality of secure gateway devices.

31. The method of claim 17 further comprising the step of:
(c) receiving at the Managed Security Server a transmission of data intended for a destination node.

32. The method of claim 31 further comprising the step of:
(d) transmitting from the Managed Security Server the transmission of data of step (c) to a secure gateway device of the plurality of secure gateway devices that corresponds to the destination node.

33. The method of claim 17 further comprising the step of.
(c) receiving IPSec configuration information from the Managed Security Server for the Secure Segment Communications Network.

34. The method of claim 17 further comprising the step of:
(c) receiving IKE configuration information from the Managed Security Server for the Secure Segment Communications Network.

35. A source node for accessing a Secure Segment Communications Network, wherein said Secure Segment Communications Network is configured by a Managed Security Server, said source node comprising:
a first output configured to output a request for an address to a destination node to a Managed Security Server;
an input to receive an address from the Managed Security Server in response to the request for an address to a destination node; and
a second output configured to output data to a destination node according to the received address.

36. The source node of claim 35 further comprising:
wherein the Secure Segment Communications Network is configured by a second Managed Security Server in the event the Managed Security Server fails.

37. The source node of claim 35 further comprising:
wherein a secure gateway device of a plurality of secure gateway devices is assigned an address that is independent of any other address on the Secure Segment Communications Network.

38. The source node of claim 35 wherein the Managed Security Server has a static public IP address.

39. The source node of claim 38 wherein a secure gateway device of a plurality of secure gateway devices has a memory, wherein the memory contains the static public IP address of the Managed Security Server.

40. The source node of claim 37 wherein the address is dynamically assigned.

41. The source node of claim 40 wherein each of the secure gateway devices of the plurality of gateway devices opens a registration channel to the Managed Security Server to convey the dynamically assigned address.

42. The source node of claim 35 wherein the request is tunneled and encrypted.

43. The source node of claim 42 wherein the request is further comprised of an IP packet, wherein the IP packet has the virtual IP address in a IP address field and a public IP address encoded as a hardware address in a hardware address field.

44. The source node of claim 35 wherein the Managed Security Server receives the request for an address and forwards the request for an address to the destination node.

45. The source node of claim 44 wherein the destination node responds to the forwarded request for an address with an address response.

46. The source node of claim 35 wherein a communication from a local area network to a second local area network is transferred by a plurality of secure gateway devices through tunneling.

47. The source node of claim 35 wherein the Managed Security Server provides tunnel configuration information to a plurality of secure gateway devices.

48. The source node of claim 35 wherein the Secure Segment Communications Network receives IPSec configuration information from the Managed Security Server.

49. The source node of claim 35 wherein the Secure Segment Communications Network receives IKE configuration information from the Managed Security Server.

50. A method of managing a Secure Segment Communications Network, wherein the Secure Segment Communications Network is further comprised of a plurality of secure gateway devices, the method comprising the steps of:
(a) connecting the plurality of secure gateway devices to a communications network;
(b) designating one of the plurality of secure gateway devices to be a Managed Security Server, wherein the Managed Security Server configures the Secure Segment Communications Network;
(c) tunneling a broadcast or multicast transmission as a uni-cast transmission on a Internet to at least one secure gateway device with a known address, including the Managed Security Server; and
(d) transmitting said broadcast or multicast transmission from the Managed Security Server to a plurality of secure gateway devices with dynamically assigned addresses.
